(19) United States
(12) Patent Application Publication
(10) Pub. No.: US 2013/0013344 A1
(43) Pub. Date: Jan. 10, 2013

(54) SYSTEMS AND METHODS FOR DETERMINING OPTIONAL INSURANCE COVERAGES

(76) Inventors: Kelly A. Ernstberger, Kingsville, MD (US); Sally D. Marston, Deep River, CT (US)

(21) Appl. No.: 13/179,120

(22) Filed: Jul. 8, 2011

(51) Int. Cl. G06Q 40/00

(52) U.S. Cl. 705/4

(57) ABSTRACT

Exemplary embodiments automatically determine and present optional insurance coverages that may be added to a base insurance coverage based on relevant characteristics of the customer. Relevant characteristics may include the characteristics of the customer's business operations. In various embodiments, optional coverages may be chosen to be similar to the optional coverages historically purchased by insured customers that have similar characteristics to the current customer, (e.g., similar business operations and risk profiles). In some embodiments, the automatic determination of optional coverages may also, or alternatively, be conditioned on the business objectives and policies of the company offering the insurance and/or on customer or user feedback regarding previously offered optional coverages.

### FIELD OF THE INVENTION

This invention relates to insurance coverage, and more particularly, to determining and presenting customized optional coverages for an insurance product.

### BACKGROUND

Most types of insurance are packaged and offered as a base product to which various optional coverages or optional endorsements may be added. For example, a base automobile insurance policy product may consist of collision and comprehensive coverage, to which optional rental car coverage and towing coverage may be added. For another example, a base insurance product for a small business owner (e.g., a business owner's policy, or BOP), may consist of both property and liability insurance that covers the business in the event of property damage, suspended operations, or lawsuits resulting from bodily injury or property damage to others, and the BOP may have available dozens of optional coverages that may be added to encompass the needs of each individual business owner.

Typically, an insurance agent or customer service representative uses an insurance company's, or insurance agency's, quote, rate and issue (QRI) system to create an insurance policy for a new customer, e.g., an entity that wishes to purchase insurance. A typical, conventional, QRI system requires the agent to navigate various graphical user interface (GUI) screens and manually select all of the coverages, both for the base product and any optional coverages that the agent desires. In addition, the agent must manually enter all of the parameters for each selected coverage, such as limits, deductibles, etc. A few conventional QRI systems present default optional coverages based on predefined user preferences, which are typically stored in a user profile created by each individual agent or customer service representative. In such systems, each user may preselect a set of optional coverages for each base insurance product, and the QRI system will always present those same preselected optional coverages every time that user is creating an insurance policy. Consequently, the QRI system performs no algorithmic computations to determine optional coverages, and the same preselected optional coverages are offered to all customers, regardless of the customer's individual risks and needs. In addition, different agents typically have different preselected optional coverages displayed for any given insurance product. Thus, there is no uniformity across agents in product offerings and agents can preselect any optional coverages they wish without regard to the business goals or policies of the insurance company.

In other words, for conventional QRI systems, the display of optional coverages for a base insurance product is based solely on the identity of the user—i.e., based solely on the agent's preselected choices of what to display. All risks quoted by the agent will default to the preselected options saved in the agent's user profile.

There are several drawbacks to conventional QRI systems. One drawback is that conventional QRI systems do not take into account any specific risk characteristics of the customer when presenting optional coverages, so inappropriate options may be presented for some customers. In many QRI systems, optional coverages preselected by the agent are presented as “included” with the base policy (i.e., the default is that the optional coverage is quoted as part of the total policy), so when an inappropriate optional coverage that has limited or no applicability to the customer's specific risks is presented, the agent must deselect or delete the optional coverage. This causes inefficient additional work for the agent.

Another drawback is that conventional QRI systems rely on the user, and the user's experience, to select appropriate optional coverages, without regard to the coverages or experiences of similar customers and without regard to the business objectives of the company offering the insurance products. If the agent is inexperienced or overlooks something, this may result in coverage gaps for a new customer's operations. Yet another drawback is that presenting inappropriate optional coverages waste valuable screen display space, as the available space on the quotation screens of a QRI system is typically very limited due to the large volume of information that must be presented.

It is desirable to provide systems and methods that address the drawbacks noted above, including systems and methods that calculate and display optional coverages that are dynamically customized or tailored in real time to be appropriate for the customer's needs and risks. It is also desirable to provide systems and methods that take into account the coverages purchased by similar, previous customers when determining tailored optional coverages to present to a new customer or renewal customer. It is further desirable to provide systems and methods that take into account the business aims of the insurance product provider when choosing optional coverages to present to a new customer or renewal customer.

### BRIEF DESCRIPTION OF THE DRAWINGS

The accompanying drawings, which are incorporated in and constitute a part of this specification, illustrate embodiments of the invention and together with the description, serve to explain the principles of the invention. Wherever convenient, the same reference numbers have been used to refer to the same or similar components. In the figures:

FIG. 1 is an exemplary flow chart for customizing optional insurance coverages, consistent with embodiments of the invention;

FIG. 2 is a block diagram of an exemplary system for insurance quotation, consistent with embodiments of the invention;

FIG. 3 is an architecture diagram of an exemplary system for providing customized optional insurance coverages, consistent with embodiments of the invention;

FIG. 4A is an exemplary flowchart for determining and presenting optional insurance coverages, consistent with embodiments of the invention;

FIG. 4B is an exemplary flowchart for computing optional insurance coverages, consistent with embodiments of the invention;

FIG. 5 is a depiction of an exemplary graphical user interface for displaying a quote summary including customized optional coverages, consistent with embodiments of the invention;

FIG. 6 is a depiction of another exemplary graphical user interface for displaying a quote summary including customized optional coverages, consistent with embodiments of the invention;

FIG. 7 is a block diagram of an exemplary computing or data processing system that may be used to implement embodiments consistent with the invention;

FIGS. 8A-8C depict an exemplary table representing logic for determining optional coverages that are tailored for a specific customer; and

FIG. 9 is a block diagram of an exemplary underwriting system incorporating an embodiment of the invention.

### DESCRIPTION OF EMBODIMENTS

Embodiments consistent with the present disclosure automatically determine and present optional insurance coverages that are added to a base transaction coverage request to address the particular risk characteristics of a customer, such as the risk characteristics associated with the customer's business operations. In various embodiments, optional coverages may be selected to be similar to the coverages historically provided to existing customers that have similar risk characteristics (e.g., similar business operations). In some embodiments, other factors influencing the automatic determination of optional coverages may be the business objectives and conditions of the company offering the insurance products and/or recent customer or user feedback regarding previously offered (but perhaps not purchased) optional coverages. Embodiments consistent with the principles of the invention may be implemented for various types of insurance or surety products that may be sold with optional coverages, such as business insurance, automobile insurance, recreational vehicle insurance, workers compensation insurance, life insurance, medical insurance, and the like.

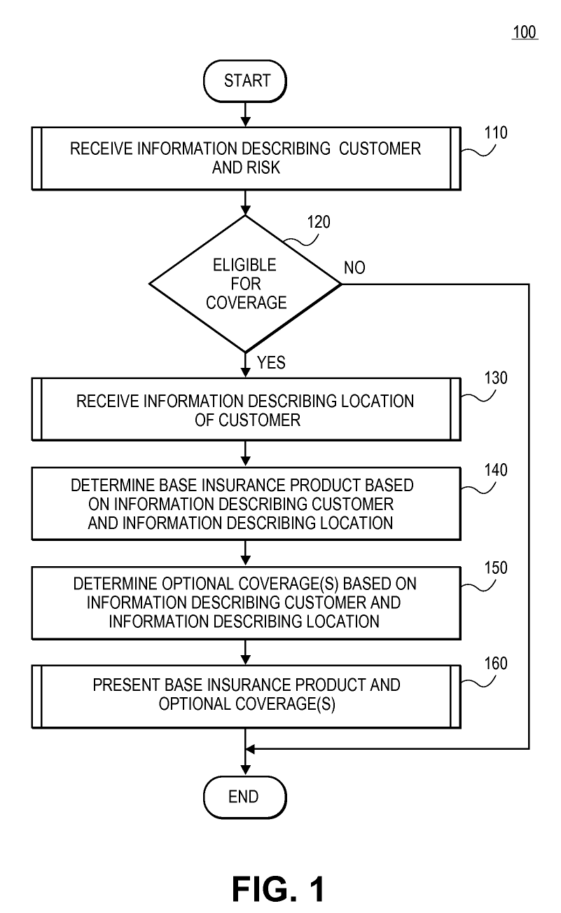

FIG. 1 is an exemplary flow chart 100 for customizing optional insurance coverages, consistent with embodiments of the invention. In various embodiments, flow chart 100 may be implemented in hardware, software, or firmware. For example, flow chart 100 may be implemented by a server computer executing a software application or applications. In the embodiment shown in FIG. 1, the boxes with double vertical sides represent actions, stages, or operations that may be associated with a user-interface, such as a GUI, wherein information is received from, or presented to, a user, such as an insurance agent.

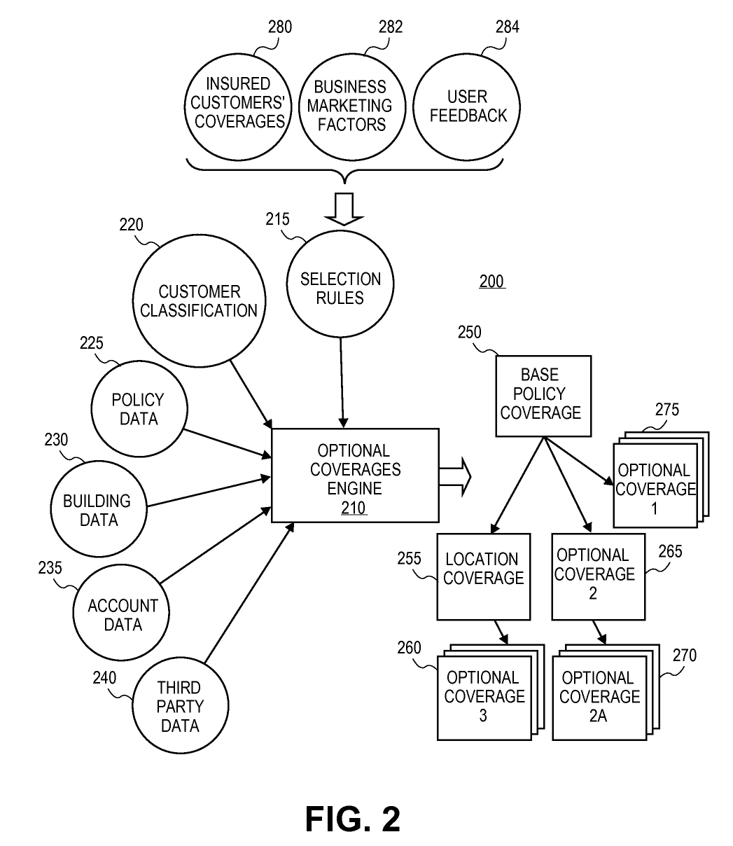

As shown in FIG. 1, flow chart 100 begins by receiving information describing a customer and the risks to be insured (block 110). For conciseness and clarity of description, an entity that is engaged in purchasing an insurance product (i.e., a potential insured) is referred to as a customer, or as a new customer, or as a renewal customer, although the entity may not yet have completed the purchase transaction. The potential insured entity may be a person, corporation, partnership, non-profit organization, or other legal entity. In some embodiments related to business insurance, the received information at this point may include information describing the customer's business operation, such as a business name, an address of the business, number of years in business, the identity of the legal entity being insured, type of business, and/or other like information. In various embodiments, the information received in this block is represented by the policy data 225 and account data 235 of FIG. 2. In some embodiments, at least a portion of the information is supplied by a user, such as an insurance agent or customer service representative, who is interviewing or otherwise obtaining the information from a customer. In other embodiments, a portion of the information may be automatically provided by a computing system from a database or the like. In still other embodiments, at least a portion of the information may be provided by a customer. Thus, in those “direct to customer” embodiments, the user may be the customer.

At block 120, flow chart 100 determines whether or not the customer is eligible for insurance coverage. In some embodiments, at this block, flow chart 100 may collect additional information about the customer, such as credit information from Dun and Bradstreet, Inc., to aid in the determination. In some embodiments at this block, flow chart 100 may determine a business classification for the customer in order to accurately characterize and assess the risks associated with the customer.

If the customer is not eligible for coverage (block 120, No), then flow chart 100 ends. If, on the other hand, the customer is eligible for coverage (block 120, Yes; e.g., the risks associated with the customer are within the risk appetite of the insurance company), then flow chart 100 proceeds to block 130.

At block 130, flow chart 100 receives information describing a location associated with the customer. In various embodiments related to business insurance, this information may include address(es) of business operations, premises information, building risk profile information, building construction information, and the like. In some embodiments, the information requested and gathered in this block may be dependent upon the business classification previously determined for the customer.

In some embodiments, block 130 may also involve receiving information from third party sources related to the location/property of the customer. For example, a third party, such as Marshall & Swift/Boeckh, LLC, may provide building replacement cost information to compute an insurance-to-value ratio, a third party such as Insurance Services Office, Inc., may provide public protection classification information, building code effectiveness grade information, tax information, and/or territory information for the location, a third party such as Proxix Solutions, Inc., may provide GEO codings, the longitude and latitude of the property location, and catastrophic risk area information, etc.

At block 140, flow chart 100 next determines an appropriate base insurance product for the customer based on the information describing the customer (from block 110) and the information describing the location (from block 130). In various embodiments, the base insurance product may be a single coverage or a multi-coverage composite insurance product. In some embodiments, determining the base product may also include determining an insurance company that should write the coverage.

In various embodiments, pricing for the base insurance product may also be determined at this point. Pricing is typically proportional to risk and exposure, so the information describing the customer and the information describing the location of the customer may affect the price of an insurance product. For example, a customer who falls into a high risk actuarial classification (e.g., young male auto drivers) may be in a higher pricing track than a customer with a different classification. Similarly, a customer has who has filed claims for losses in the past may be in a higher pricing track than a customer who has never filed a claim. The risk nature of the customer's business may also be a factor in pricing.

Flow chart 100 next determines optional coverage(s) to add to the base insurance product, based on the information describing the customer, (which, for business insurance, includes information describing the customer's business operations) and the information describing the location of the customer (block 150). In some embodiments, the type of base insurance products may also influence, or be a factor in, determining the optional insurance coverage(s). In some embodiments, the limits for the optional coverage(s) may also be determined at this point. In this block, the optional coverages and limits are customized or tailored to each individual customer according to the information describing the customer, which may include information describing the location of the customer's business. In some embodiments, the price(s) of the custom optional coverage(s) are also computed at this time, in a fashion similar to the pricing of the base insurance product.

At block 160, flow chart 100 presents the base insurance product and the optional coverage(s), and then ends. In some embodiments, there may be an indirect presentation of the optional coverage(s) through an insurance agent who is working with the customer. In various embodiments, the base insurance product and the optional coverage(s) may be presented within a quote summary display on a computer, and this display may show the base product coverages along with the optional coverages that have been automatically added as default choices to address the needs of this particular customer.

One of ordinary skill will recognize that blocks may be added to, deleted from, modified, or reordered in flow chart 100 without departing from the scope of the invention. For example, blocks 140 and 150 could be combined into a single block or block 130 could be deleted for insurance products which do not utilize location information.

FIG. 2 is a block diagram of an exemplary system 200 consistent with embodiments of the invention. As shown in FIG. 2, an “optional coverages engine” 210 receives input information 215-240 and generates output data in the form of optional coverages 260-275, which accompany a base insurance product, such as base policy coverage 250 and location coverage 255.

In the embodiment shown in FIG. 2, selection rules 215 are the rules used by optional coverages engine 210 to determine optional insurance coverages. In various embodiments, the rules may be implemented as statements that define or constrain the choice of optional coverages depending on the information in other inputs 220-240. In various embodiments, selection rules 215 may be formulated to compute optional coverages for a customer that are the same as, or similar to, the optional coverages chosen by already insured customers that are similar to the customer, as represented by insured customers' coverages 280. In these embodiments, the optional coverages picked for a new or renewal customer are tailored to be similar to the optional coverages purchased by previous customers that are alike in nature and risk characteristics to the new or renewal customer.

In some embodiments, selection rules 215 may also be formulated and/or updated to calculate appropriate optional coverages for a customer by taking into account business and/or marketing factors 282, which may include business objectives of an insurance company. For example, selection rules 215 may be designed to incorporate a business objective of an insurance company by selecting a newly introduced optional coverage that the insurance company wishes to sell more of, because the new option will better protect customers. For another example, an organization's business objective may be to sell less of a specific optional coverage in an area where it has a low risk appetite, for instance, in a business risk area in which an insurance company does not wish to increase its exposure. For yet another example, selection rules 215 may be updated based on analytics investigations of various types of business data. Other business objectives may also be used as factors in choosing optional insurance coverages.

In some embodiments, selection rules 215 may be formulated and/or updated to choose optional coverages for a customer by taking into account user feedback 284. User feedback 284 may be in the form of purchasing (or declining to purchase) decisions, comments from customers and agents, etc. For an example with regard to purchasing decisions, if recently insured customers or their agents frequently or consistently choose to decline or remove a particular optional coverage calculated by a set of selection rules 215, then the selection rules 215 may be modified to cease outputting that particular optional coverage because there is no marketplace demand for it. For an example with regard to customer comments, recently insured customers, or their agents, may submit written or verbal statements regarding optional coverages that they wish had been offered to them, that they regret purchasing in hindsight, that they wish had a lower deductible, etc.; and selection rules 215 may be modified to reflect the feedback comments.

In the embodiment shown, another input to optional coverages engine 210 is customer classification data 220, which includes information indicating a category or a classification for the customer that can be used to identify other customers in the same or a similar category, access insurance data from other customers in the same or a similar category, apply selection rules 215 as appropriate based on the category or classification for the customer, and perform other like actions. For example, customer classification data 220 may place a business insurance customer into a specific business segment classification or industry segment classification, such as apartment building owner, contractor, manufacturer, restaurant owner, etc. In some embodiments, customer classification data 220 may be generated by an automated system, for example as described in U.S. patent application Ser. No. ______, entitled “Systems and Methods for Enhanced Business Classification,” filed Jul. 8, 2011, with attorney docket number TR01-009-01, which is hereby incorporated by reference in its entirety. In other embodiments, customer classification data 220 may be provided by an insurance agent who has gathered information from the customer, or it may come from other sources.

In various embodiments, customer classification data 220 may include information that is used by optional coverages engine 210 to identify similar existing customers having similar risk profiles and/or that may be used to determine a category or classification for the customer, so that the customer may be correlated with other customers in the same or a similar category. For example, in embodiments for business insurance, customer classification data 220 may include information such as business name, address, years in business, legal entity, type of business, etc.

The next input, policy data 225 includes information indicating a base insurance product desired or needed by a customer. For example, policy data 225 may indicate a small business owner's policy, an automobile policy, etc., as the base insurance product. In some embodiments, policy data 225 may be generated by an insurance agent who has gathered information from the customer and recommended the base insurance product. In various embodiments, policy data 225 encompasses a base policy coverage 250, as optional coverages engine 210 may use information about the base policy coverage 250 to determine which optional coverage(s) to select for a given user. For example, optional coverages engine 210 may perform one algorithm to determine a customized set of optional coverages for automobile insurance base policy coverage 250, and perform a different algorithm to determine a customized set of optional coverages for a business owner's insurance base policy coverage 250. Similarly, for a multi-coverage insurance product that consists of base policy coverage 250 and location coverage 255, as shown in FIG. 2, policy data 225 may include both base policy coverage 250 and location coverage 255 as inputs to optional coverages engine 210.

Building data 230 includes information describing a building or other location that a customer wishes to insure. For example, building data 230 may specify the building's address, age, construction, etc. In some embodiments, building data 230 may be generated by an insurance agent who has gathered information from the customer describing the characteristics of the customer's business building.

Account data 235 includes information describing an account associated with the customer. For example, account data 235 may specify other insurance products that the customer has, multi-policy discounts, claims history, payment history, accounts receivable, etc. In some embodiments, account data 235 may be generated by an insurance agent who has gathered information from the customer and/or accessed records of the customer's existing policies and previous transactions.

Third party data 240 includes information that comes from outside sources that are not directly related to providing insurance. For example, third party data 240 may include geo-coding information for a building, an estimated value for a building, a Standard Industrial Classification (SIC) code for a business, etc. In some embodiments, third party data 240 may be provided by information vendors, such as Dun & Bradstreet, Inc., Proxix Solutions, Inc., Insurance Services Office, Inc., CDS Business Mapping, LLC., etc.

In the embodiment shown, optional coverages engine 210 receives inputs 215-240 and computes a set of zero or more optional insurance coverages based on the inputs that describe the risks and characteristics of the customer. In the embodiment shown, optional coverages engine 210 may be implemented as a rules engine application executing on a computing system, which performs calculations for choosing optional coverages according to selection rules 215. In other embodiments, optional coverages engine 210 may be implemented using techniques and technology that does not employ a rules engine, and selection rules 215 may not be present in such embodiments. In non-rules embodiments, the functionality of selection rules 215 may be incorporated directly into the computation logic, or other computation techniques may be used. Other arrangements of hardware and/or software providing comparable results may also be used.

As shown in FIG. 2, base policy coverage 250 is the basic insurance product desired by the customer. In various embodiments, base policy coverage 250 is specified by policy data 225, which may be provided by an agent who is servicing the customer. For example base policy coverage 250 may be a business owner's policy recommended by the agent. Similarly, location coverage 255 is another base insurance product desired by the customer. For example, location coverage 255 may be basic building insurance, which is often provided in conjunction with a business owner's policy for businesses that own a building, as part of a multi-coverage insurance product. In various embodiments, location coverage 255 is specified by policy data 225, which may be provided by an agent who is servicing the customer.

In the example shown in FIG. 2, several optional coverages have been generated as output by optional coverages engine 210. Optional coverage 1 275 is a discretional coverage that may be added to base policy coverage 250. Similarly, optional coverage 2 265 is another discretional (e.g., available-to-be-chosen) coverage that may be added to base policy coverage 250. Optional coverage 2A 270 is a discretional coverage that may be added to base policy coverage 250 if optional coverage 2 265 is present. And, optional coverage 3 260 is an optional coverage that may be added to base location coverage 255. As noted above, base policy coverage 250 and location coverage 255 may be inputs to optional coverages engine 210, in various embodiments. In such embodiments, base policy coverage 250 and/or location coverage 255 may be determined by separate processes and computations.

One of ordinary skill will recognize that elements may be added to, removed from, or modified within system 200 without departing from the principles of the invention. For example, building data 230 may be removed as inapplicable for embodiments related to automobile insurance, life insurance, unemployment insurance, etc.

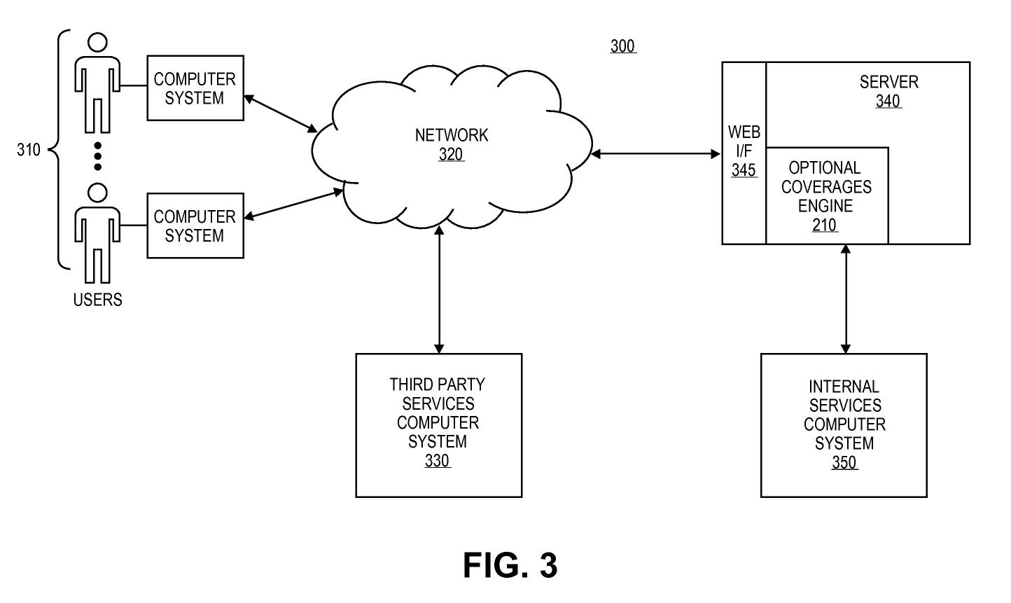

FIG. 3 is an architecture diagram of an exemplary system 300 for providing customized optional insurance coverages, consistent with embodiments of the invention. In the embodiment shown, users 310 interact with a server 340 via a network 320. In various embodiments, users 310 may be insurance agents or customer service representatives, who are connecting to network 320 using a computer system, such as laptop computer or a desktop computer, and who are working with, and obtaining information from, a customer. In some embodiments, users 310 may also be customers, (e.g., purchasers of insurance), who are interacting directly with server 340. In those embodiments, system 300 may be adapted for direct end-customer use without departing from the scope of the invention. In various embodiments, network 320 may be a digital telecommunications network, such as the Internet and/or a private network. Other types of networks may also be used. In various embodiments, server 340 may be a computer whose hardware and/or software resources are shared with other computers.

In the embodiment shown in FIG. 3, server 340 includes an optional coverages engine 210, which may be implemented as a dedicated software application, as a component of a larger software application that quotes, rates and issues an insurance policy, in firmware, or in hardware. Optional coverages engine 210 may perform operations related to responsively computing and presenting optional insurance coverages that are tailored for each customer when the customer purchases insurance. Server 340 also includes a web interface 345, in the embodiment shown. Web interface 345 allows server 340 to function as a web server, and users 310 may interact in real time with server 340 using web interface 345. In some embodiments, users 310 may also provide information to server 340 by uploading files from an agency management system to server 340, as opposed to via an interactive GUI. In such embodiments, the uploaded files may be in the form of XML files, for example, and they may contain information similar to the information provided by an agent when interacting with server 340 via a GUI provided by web interface 345. Other data transfer arrangements using known or later-developed data formats may also be used.

System 300 also includes third party services computer system 330, which may communicate with server 340 via network 320, as shown. In some embodiments, third party services computer system 330 may communicate with server 340 via a private network (not shown), private communications link (not shown), or other network connection, while users 310 interact with server 340. Third party services computer system 330 may include vendors that provide information about customers that can be used to assess risks associated with the customers, including vendors, such as Dun & Bradstreet, Inc., Proxix Solutions, Inc., Insurance Services Office, Inc., CDS Business Mapping, LLC., etc.

System 300 also includes internal services computer system 350, which may communicate with server 340 via a direct connection, as shown, or via a network (not shown), while users 310 interact with server 340. In various embodiments, internal services computer system 330 may include ancillary functions and information needed to quote, rate and issue an insurance policy for a customer, such as a rating service, a CGI service, a forms service, a pricing service, etc.

In some embodiments of system 300, the communications between server 340 and users 310, third party services computer system 330, and internal services computer system 350 may be implemented in real time via XML transfers. If the various components use different types or versions of XML, then server 340 may employ translation or transformation software to convert one format of XML to another, as needed. Other data transfer arrangements using known or later-developed data formats may also be used.

One of ordinary skill will recognize that system 300 is necessarily simplified for conciseness and clarity of explanation, and that components may be added to, deleted from, modified, or combined in system 300 without departing from the scope of the invention.

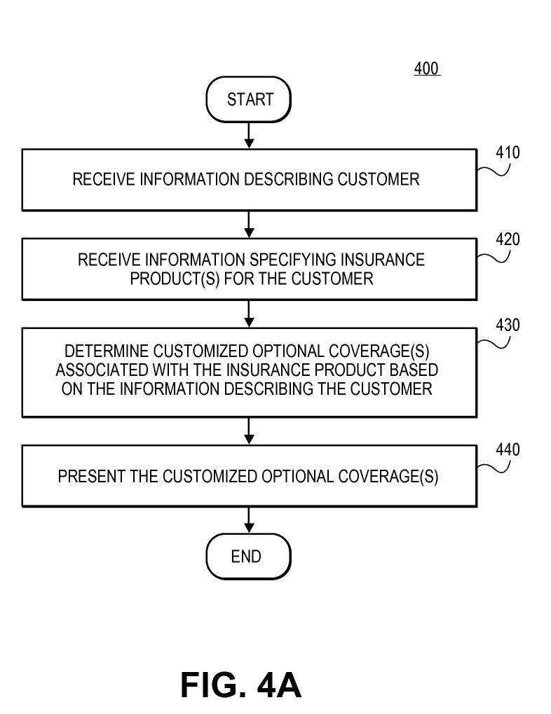

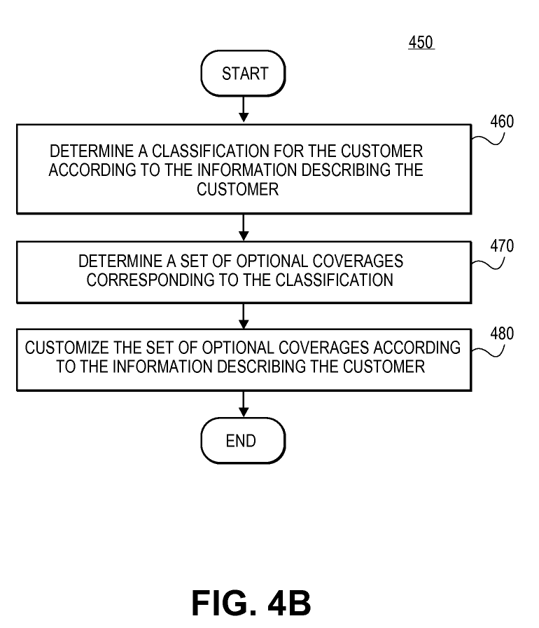

FIG. 4A is an exemplary flowchart 400 for determining and presenting optional insurance coverages, consistent with embodiments of the invention. In various embodiments, flow chart 400 may be implemented in hardware, software, or firmware. For example, flow chart 400 may be implemented by optional coverages engine 210 executing on a general-purpose computing system.

In the embodiment shown, flow chart 400 begins by receiving information describing a customer (block 410). In some embodiments, the information describing the customer may include customer classification data 220, building data 230, account data 235 and third party data 240, as shown in FIG. 2. In various embodiments, information describing the customer may be received via a user interface to a software application, via a digital file transfer from a computer system, via the results of a database search, or the like.

Flow chart 400 continues with receiving information specifying an insurance product(s) for the customer (block 420). In some embodiments, the information specifying the insurance product(s) for the customer may include policy data 225 and account data 235, as shown in FIG. 2. For example, the information specifying insurance product(s) may be information describing a base policy coverage 250 (such as a general liability policy) and describing a location coverage 255 (such as a property policy). In various embodiments, information specifying the insurance product(s) may be received via a user interface to a software application, via a digital file transfer, via a database search, or the like.

At block 430, flow chart 400 determines customized optional coverage(s) associated with the insurance product, wherein the optional coverage(s) are created in response to and based on the information describing the customer received in block 410. In various embodiments, flow chart 400 may determine the optional coverage(s) for the customer by selecting optional coverage(s) that were purchased in the past by insured entities that are similar to the current customer. There is a high likelihood that insured entities that are similar to the current customer have risks similar to those of the current customer, and therefore that the insured entities have purchased coverage that is indicative of the coverage needed by the current customer. In such embodiments, flow chart 400 may identify insured entities that are similar to the current customer by finding insured entities that have substantially the same characteristics or attributes as those of the customer, such as insured entities that are in the same line of business, insured entities that own similar buildings, insured entities that are demographically similar, insured entities that have insured the same make and model of vehicle, etc.

For example, consider a customer that is purchasing a business owner's insurance policy and that is characterized as an apartment building owner. In this example, after receiving the customer information in block 410, block 430 of flow chart 400 may search a database of issued business owner's policies and identify a subset of business owner's policies that were issued to apartment building owners. Block 430 may analyze this subset of business owner's policies in comparison to a predetermined threshold percentage (and/or other criteria) and determine that a significant portion (e.g., >30% or >50% or at least 60%) of the business owner's policies for apartment building owners include optional coverage for mold/fungus risk. Based on this analysis, block 430 may therefore include mold/fungus coverage as one of the optional coverages computed as a selection for the customer, as it logically follows that the new-customer apartment building owner needs to protect against a mold/fungus risk, just as previously insured apartment building owners did. Thus, in this example, the optional coverage chosen for the customer is customized or tailored according to the apartment-building-owner characteristic of the customer.

Now consider an example wherein the same customer is purchasing a business owner's insurance policy, but instead of operating an apartment building, the customer is operating a garage performing automotive services and repairs. In this example, after receiving the customer information in block 410, block 430 of flow chart 400 may search a database of issued business owner's policies and identify a subset of business owner's policies that were issued to garage business owners. Block 430 may analyze this subset of business owner's policies in comparison to a predetermined threshold percentage (and/or other criteria) and determine that less than a significant portion (e.g., <50%) of the issued business owner's policies for garage owners include optional coverage for mold/fungus risk. Consequently, in this example, flow chart 400 will not propose mold/fungus coverage as an optional coverage for this customer. Block 430 may further determine from analysis of issued garage owner policies that it is desirable for garage owners to have a $0 deductible for their property damage coverage (as opposed to the standard $2000 deductible that is offered to most other types or categories of businesses). Based on this analysis, block 430 may therefore present a $0 property damage deductible as one of the optional coverages computed for the garage-owner customer. Thus, in this example, the optional coverage chosen for the customer is different from the previous example, because the customized optional coverage(s) are now computed according to the garage-owner characteristic of the customer.

In various embodiments that utilize a threshold applied to the existing book of business to determine appropriate optional coverages for a customer, the level of the threshold (e.g., 1% to 99%) may be set in accordance with various factors, including business drivers for an insurance company, observed or anticipated changes in risk for customers having specific characteristics, observed or anticipated changes in market demand for various optional coverages, etc.

After determining the appropriate optional coverage(s) (if any) for the customer, flow chart 400 presents the determined optional coverage(s), for example via a computer display or a printout, and then ends (block 440). In some embodiments the optional coverage(s) may be presented to an agent of the customer, such as an insurance agent, who then presents the optional coverage(s) to the customer. In other embodiments, where the customer is the user, the optional coverage(s) may be presented directly to the customer. In various embodiments, the optional coverage(s) may be presented via a user interface to a software application, via a digital file transfer, or via other like means.

One of ordinary skill will recognize that blocks may be added to, deleted from, modified, or reordered in flow chart 400 without departing from the scope of the invention. For example, blocks 410 and 420 could be reversed in order.

FIG. 4B is an exemplary flowchart 450 for determining optional insurance coverages, consistent with embodiments of the invention. In some embodiments, flow chart 450 may be used to implement block 430 of flow chart 400. In various embodiments, flow chart 450 may be implemented in hardware, software, or firmware. For example, flow chart 450 may be implemented by optional coverages engine 210 executing on a general-purpose computing system.

As shown in the example of FIG. 4B, flow chart 450 begins by determining a classification for the customer according to the information describing the customer (block 460). For instance, in embodiments related to business insurance, block 460 may classify the customer into one of several business segment classifications, for example, an apartment segment for owners of buildings used as apartment houses, cooperatives, etc.; a commercial building segment for lessors of commercial buildings occupied by offices, mercantile and retail establishments, and the like; a consumer business segment for businesses providing personal consumer services, businesses repairing light consumer goods, businesses engaged in printing, and the like; a condominium segment for owners of buildings used as condominiums; a contractors segment for primarily small residential, special trade contractors; a garage segment for independently operated or franchised automotive service and repair businesses; a manufacturers segment for manufacturers of electronics, food products, leather goods, instruments, metal goods, paper products, plastic goods, rubber products, textiles, wood products, and the like; an office segment for firms providing medical, legal, financial or other professional services for their clientele; a religious segment for churches and other houses of worship not affiliated with operating educational institutions; a restaurant segment for food service establishments; a store segment for a variety of retailers primarily engaged in brick-and-mortar commerce; a technology office segment for technology firms providing computer consultation and a variety of technology services for their clientele; a technology manufacturers segment for manufacturers of electronics and instruments products; and a wholesalers segment for distributors of various types of durable and non-durable domestic goods. For another example, in embodiments related to automobile insurance, block 460 may classify the customer into one of several actuarial risk segments, such as a males age 16-24 segment; a males age 25-38 segment; a males age 39-60 segment; a males age 61 and over segment; a females age 16-24 segment; a females age 25-46 segment; and a females age 47 and over segment. Other classification categories or segments, which may be based on risks associated with the segments, may also be used for various types of insurance.

In some business insurance embodiments, operations and actions associated with this block may be performed by an automated business classification system, for example as described in U.S. patent application Ser. No. ______, (specified above), which produces customer classification data 220, as shown in FIG. 2. In other embodiments, the classification determination may include reading a classification variable in the information describing the customer, as provided by an insurance agent or other user who has gathered information from and/or evaluated the customer.

In some embodiments, the classification may be a multidimensional or multivariable characterization of the customer, such as a classification that places the customer into a subcontractor business category, with a subcategory of interior painter, or plumber, or carpenter, etc. Other classification categories and subcategories may include geographic location, legal entity, employee count, type of profession, actuarial group, employee type, and the like.

At block 470, flow chart 450 determines a set of zero or more optional insurance coverages corresponding to the determined classification, tailoring the set of optional coverages to the characteristics of the customer as indicated by the classification of block 460. In various embodiments, this block may be implemented using rules and a rules engine. In some such embodiments, the rules may be designed to determine optional coverage(s) that were purchased in the past by insured entities that have the same classification as the customer. For example, a set of existing, already-purchased policies belonging to the same classification as the customer may be analyzed to identify the most commonly added optional coverages, and the rules may be designed according to this analysis to select a set of those same optional coverages in block 470. For instance, if the most commonly purchased optional coverage for a business owner's policy product is mold/fungus coverage when the purchaser is classified as an apartment building owner, then a rule such as:
IF classification=apartment building owner THEN
   optional coverage=mold/fungus
      may be implemented in block 470. This exemplary rule considers a single characteristic of the customer (whether the customer has been classified as an “apartment building owner”) and chooses the mold/fungus optional coverage if the customer has indeed been classified as an “apartment building owner.” In other embodiments, a rule or rules may consider multiple characteristics of the customer and select multiple optional coverages that correspond to those characteristics.

In some embodiments, various rules may be designed to implement business or marketing preferences. For example, the rules may be designed not to select optional coverages that the insurance company does not wish to sell, for example, for reasons of limiting exposure in certain risk areas, or the rules may be designed to offer a new type of optional coverage to customers having appropriate characteristics so that the insurance company may sell more of the new type of optional coverage. Other criteria, goals, analyses of books of business, and preferences may also be used to design the rules for calculating a set of optional coverages, without departing from the scope of the invention.

At block 480, flow chart 450 may further customize the set of optional coverages according to the information describing the customer. In some embodiments, block 480 may evaluate additional characteristics or attributes of a customer (i.e., in addition to the classification determined in block 460) and select (or eliminate from the selection of the previous block or the selection of an agent) optional coverage(s) based on those characteristics or attributes. For example, in a rules-based implementation, block 480 may implement one or more rules such as:
IF (classification=any) AND (prior EPL claims=0) AND (state=Utah) THEN
   optional coverage=employment practices liability version 1;
ELSE
   optional coverage=employment practices liability version 2.

This exemplary rule considers three different characteristics or attributes of the customer: 1) the classification of the customer's business (in some embodiments, this information may come from customer classification data 220); 2) whether the customer has previously filed a claim under employment practices liability (EPL) coverage (in some embodiments, this information may come from account data 235); and 3) whether the customer's location is in the state of Utah (in some embodiments, this information may come from policy data 225 and/or third party data 240). In this exemplary rule, the classification of the customer's business is not limiting, and if the customer has no prior EPL claims and is located in the state of Utah, then block 480 causes “employment practices liability version 1” to be output as an optional coverage for the customer. If, on the other hand, the customer has one or more prior EPL claims and/or is not located in the state of Utah, then block 480 causes “employment practices liability version 2” to be output as an optional coverage for the customer.

For another example, in a rules-based implementation, block 480 may implement a rule such as:
IF (building coverage is not selected) THEN
   optional coverage=damage to rented property.

For yet another example, in a rules-based implementation, block 480 may implement a rule such as:
IF (automobile policy is not selected) AND (legal entity is not partnership) AND (employee count is less than 50) THEN
   optional coverage=hired auto coverage.

Other examples of rules or algorithms for computing appropriate optional coverages for a customer include:
IF (classification=store business segment) THEN
   optional coverage=Power Pac (where “Power Pac” represents a group of optional coverages that are bundled together into one optional multi-coverage product);
IF (classification=office business segment) AND (program code=accountant) THEN
   optional coverage=accountants endorsement;
IF (building coverage is selected) THEN
   optional coverage=building owner's endorsement;
IF (customer's account does not include auto policy) THEN
   optional coverage=hired auto coverage AND optional coverage=non-owned auto coverage;
IF (classification=garage business segment) AND (program code=accountant) THEN
   optional coverage=general liability deductible of $0.

In various embodiments, any number of rules may be implemented to customize the determination of optional coverage(s) according to the characteristics of the customer. Several rules may be implemented and their outputs combined to form a set of optional coverages. As noted above, in some embodiments, the set of optional coverage(s) produced by block 480 may be the output of block 430 of flow chart 400.

One of ordinary skill will recognize that blocks may be added to, deleted from, modified, or reordered in flow chart 450 without departing from the scope of the invention. For example, blocks 470 and 480 could be combined into a single block using more complex rules, or block 480 could be deleted. In addition, although exemplary implementations using rules and a rules engine have been presented, one or ordinary skill will recognize that the same functionality may be implemented using many different computer science techniques without departing from the scope of the invention. One of ordinary skill will also recognize that processes and methods, such as those represented by flow charts 100, 400, and 450, may be implemented in an iterative manner, such that after presentation of optional insurance coverages, a user may alter the received input information and repeat the process, which may result in a different set of optional coverages that conform to the new inputs being chosen and presented.

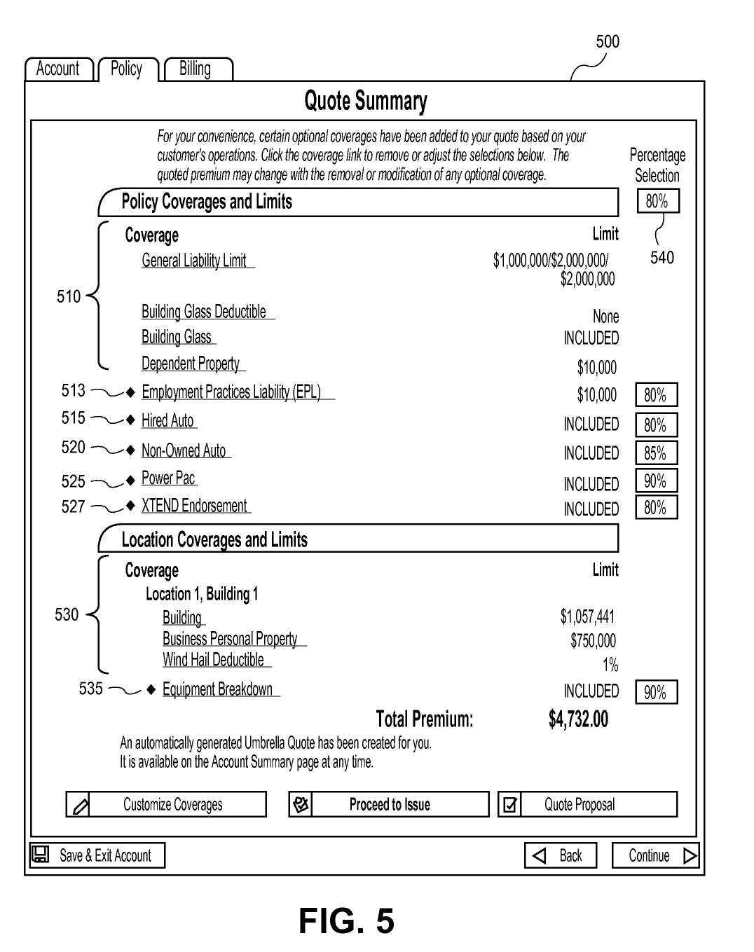

FIG. 5 is a depiction of an exemplary graphical user interface (GUI) 500 for displaying a quote summary including customized optional coverages, consistent with embodiments of the invention. In some embodiments, GUI 500 may be used to present optional coverages to a user (e.g., an insurance agent) or a customer, in accordance with block 160 of FIG. 1 and/or block 440 of FIG. 4A. In some embodiments, GUI 500 may be provided by web interface 345 of FIG. 3. Exemplary GUI 500 may be utilized by users such as insurance agents or brokers and customer service representatives of insurance companies, but one of ordinary skill will recognize that it could be adapted for direct end-customer use without departing from the scope of the invention.

In the example shown in FIG. 5, GUI 500 displays the coverages and limits of a business owner's liability policy 510 and the associated coverages and limits of a property policy 530 for the business's building. In this example, the base insurance product is a multi-coverage product for both liability and property. In addition to the base product coverages, GUI 500 also displays several optional coverages that have been added to the base coverages to comport with the characteristics of the customer. As shown, an “employment practices liability (EPL)” optional coverage 513, a “hired auto” optional coverage 515, a “non-owned auto” optional coverage 520, a “Power Pac” optional coverage 525, and an “EXTEND endorsement” optional coverage 527 are displayed with the coverages and limits of a business owner's liability policy 510. In this example, the “Power Pac” optional coverage 525 represents a group of optional coverages that are bundled together into one optional multi-coverage product, and similarly, the “EXTEND endorsement” optional coverage 527 represents another group of optional coverages that are bundled together into another optional multi-coverage product.

In conjunction with property policy 530 for the business's building, GUI 500 displays an “equipment breakdown” optional coverage 535, which has been computed in accordance with the customer's characteristics for default inclusion with this customer's policy.

In the embodiment shown, all the optional coverages are defaulted to be included in the policy (and their prices reflected in the total premium), and GUI 500 provides controls and functionality that allows a user to remove or adjust the optional coverages as desired (e.g., the “Customize Coverages” control button). In other embodiments, optional coverages may be merely suggested, requiring the user to proactively select each in order to include it in the policy. In the example shown in FIG. 5, GUI 500 denotes the automatically determined optional coverages 513, 515, 520, 525, and 535 by displaying a diamond, which may be rendered in a prominent color, adjacent and to the left of each optional coverage line. This aids the user in identifying the optional coverages that were automatically added by the system in response to the customer's descriptive information. Other techniques for highlighting the optional coverages may also be used.

In one optional embodiment, in addition to displaying a diamond or other indicator to designate the optional coverages, a box may be provided beside each optional coverage to identify the percentage of other customers who have obtained the respective optional coverage. As shown in FIG. 5, 80% of insured entities similar to the current customer have obtained EPL, Hired Auto, and XTEND Endorsement coverage; 85% have obtained Non-Owned Auto coverage, and 90% have obtained Power Pac and Equipment Breakdown coverage. In a further optional embodiment, a user may enter a percentage selection at 540 and GUI 500 will update to display only those optional coverages having the identified percentage or higher.

One of ordinary skill will recognize that GUI 500 is necessarily simplified for conciseness and clarity of explanation, and that information and controls may be rearranged or presented differently without departing from the scope of the invention.

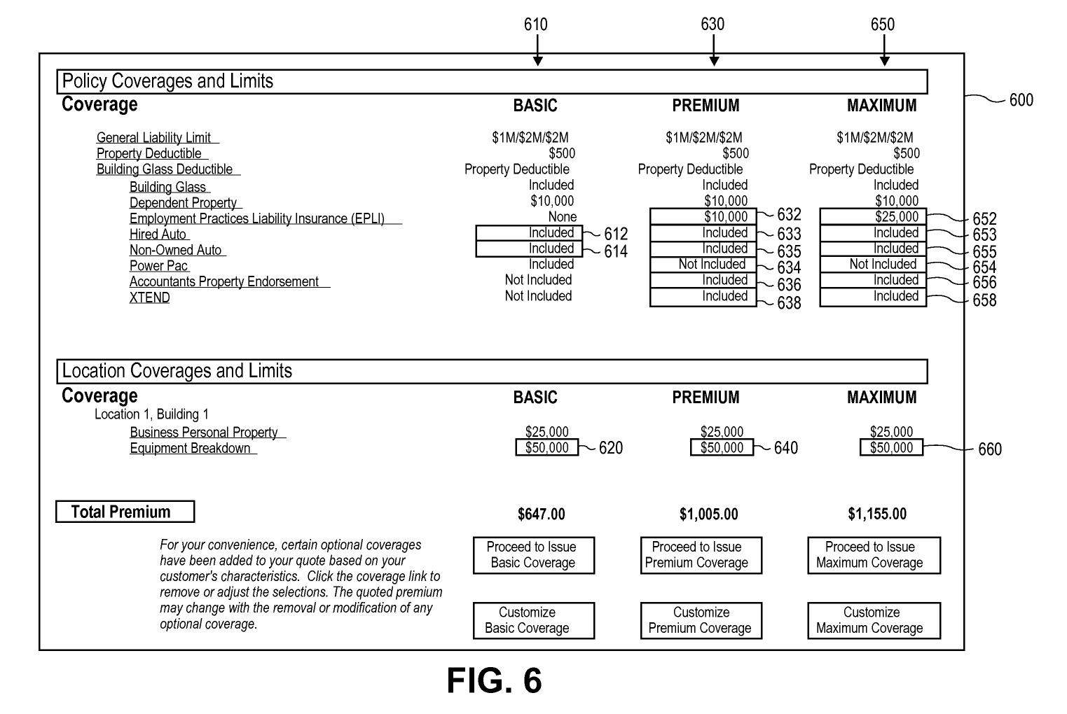

FIG. 6 is a depiction of another exemplary graphical user interface 600 for displaying a quote summary including customized optional coverages, consistent with embodiments of the invention. In some embodiments, GUI 600 may used to present optional coverages to a user and/or a customer, in accordance with block 160 of FIG. 1 and/or block 440 of FIG. 4A. In some embodiments, GUI 600 may be provided by web interface 345 of FIG. 3. Exemplary GUI 600 may be utilized by users such as insurance agents or brokers and customer service representatives of insurance companies, but one of ordinary skill will recognize that it could be adapted for direct end-customer use without departing from the scope of the invention.

In the example shown in FIG. 6, three sets of business owner policy coverages are presented for a customer who runs an accounting firm, wherein each of the sets of coverages are customized for the accountant customer. In the embodiment shown, each set of coverages in shown in a different column. “Basic” column 610 shows a first, lowest-priced, set of coverages, “Premium” column 630 shows a second, mid-priced, set of coverages, and “Maximum” column 650 shows a third, high-priced, set of coverages. GUI 600 presents a tiered pricing structure customized for a specific customer, so that the customer may better and more easily choose the level of coverage desired.

In the upper portion of the “Basic” column 610, GUI 600 displays the coverages and limits of an accounting business owner's liability policy and in the lower portion of the “Basic” column 610 displays the associated coverages and limits of a property policy for the business's building. In this example, the base insurance product is a multi-coverage product for both liability and property. In addition to the base product coverages, GUI 600 also displays in column 610 an optional “hired auto” coverage 612, an optional “non-owned auto” coverage 614, and an optional “equipment breakdown” coverage 620 that has been added to the base coverages to encompass the risk characteristics of the accounting customer. In this example, the optional coverages are denoted as being recommended options by the rectangles on the display; for example, the “equipment breakdown” coverage 620 is denoted as being an added option by the rectangle about the coverage limit $50,000.

Referring now to the “Premium” column 630, the upper portion of the column displays four optional coverages computed to fit the risk attributes of the accounting client and denoted by rectangles: EPLI coverage with a $10,000 limit 632, hired auto “included” 633, non-owned auto “included” 635, Power Pac “not included” 634 (in contrast to “included” in basic column 610), accountant's property endorsement coverage 636 included, and XTEND coverage 638 included (XTEND represents a group of optional coverages that are bundled together into one optional multi-coverage product). The lower portion of “Premium” column 630 displays one optional “equipment breakdown” coverage 640 with a $50,000 limit, denoted by the rectangle on the display.

Referring to the “Maximum” column 650, the upper portion of the column displays four customized optional coverages denoted by rectangles: EPLI coverage with a $25,000 limit 652, hired auto included 653, non-owned auto included 655, Power Pac not included 654 (“included” in basic column 610), accountant's property endorsement coverage 656 included, and XTEND coverage 658 included. The lower portion of “Maximum” column 630 displays one optional “equipment breakdown” coverage 660 with a $50,000 limit.

GUI 600 allows a user to easily issue a policy under any of the three tiers of coverage presented, or change the coverages of any of the three tiers, using the controls at the bottom of the display.

One of ordinary skill will recognize that GUI 600 is necessarily simplified for conciseness and clarity of explanation, and that information and controls may be rearranged or presented differently without departing from the scope of the invention.

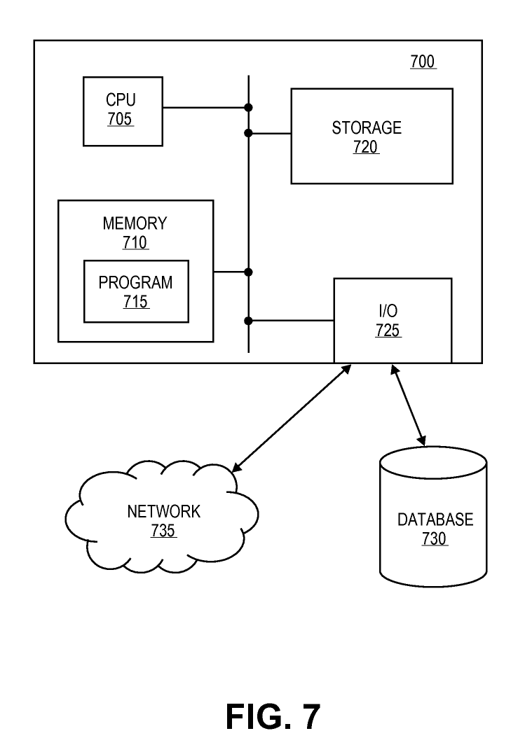

FIG. 7 is a block diagram of an exemplary computing system or data processing system 700 that may be used to implement embodiments consistent with the invention. Other components and/or arrangements may also be used. In some embodiments, computing system 700 may be used to implement server 340 of FIG. 3.

Computing system 700 includes a number of components, such as a central processing unit (CPU) 705, a memory 710, an input/output (I/O) device(s) 725, and a nonvolatile storage device 720. System 700 can be implemented in various ways. For example, an implementation as an integrated platform (such as a workstation, personal computer, laptop, smartphone, etc.) may comprise CPU 705, memory 710, nonvolatile storage 720, and I/O devices 725. In such a configuration, components 705, 710, 720, and 725 may connect and communicate through a local data bus and may access a database 730 (implemented, for example, as a separate database system) via an external I/O connection. I/O component(s) 725 may connect to external devices through a direct communication link (e.g., a hardwired or local wifi connection), through a network, such as a local area network (LAN) or a wide area network (WAN), and/or through other suitable connections. System 700 may be standalone or it may be a subsystem of a larger system.

CPU 705 may be one or more known processing devices, such as a microprocessor from the Core™ 2 family manufactured by the Intel™ Corporation of Santa Clara, Calif. Memory 710 may be one or more fast storage devices configured to store instructions and information used by CPU 705 to perform certain functions, methods, and processes related to embodiments of the present invention. Storage 720 may be a volatile or non-volatile, magnetic, semiconductor, tape, optical, or other type of storage device or computer-readable medium, including devices such as CDs and DVDs, meant for long-term storage.

In the illustrated embodiment, memory 710 contains one or more programs or subprograms 715 loaded from storage 720 or from a remote system (not shown) that, when executed by CPU 705, perform various operations, procedures, processes, or methods consistent with the present invention. Alternatively, CPU 705 may execute one or more programs located remotely from system 700. For example, system 700 may access one or more remote programs via network 735 that, when executed, perform functions and processes related to embodiments of the present invention.

In one embodiment, memory 710 may include a program(s) 715 that implements a quote, rate and issue system that implements flowcharts 100, 400, and/or 450, and/or a program 715 that implements optional coverage engine 210. In some embodiments, memory 710 may also include other programs or applications that implement other methods and processes that provide ancillary functionality to the invention. For example, memory 710 may include programs that gather, organize, store, and/or generate input data, such as customer classification data 220, policy data 225, building data 230, account data 235 and third party data 240, and programs that translate XML files from one format of XML to another.

Memory 710 may be also be configured with other programs (not shown) unrelated to the invention and/or an operating system (not shown) that performs several functions well known in the art when executed by CPU 705. By way of example, the operating system may be Microsoft Windows™, Unix™, Linux™, an Apple Computers™ operating system, Personal Digital Assistant operating system such as Microsoft CE™, or other operating system. The choice of operating system, and even to the use of an operating system, is not critical to the invention.

I/O device(s) 725 may comprise one or more input/output devices that allow data to be received and/or transmitted by system 700. For example, I/O device 725 may include one or more input devices, such as a keyboard, touch screen, mouse, and the like, that enable data to be input from an administrative user, such as a system operator. Further, I/O device 525 may include one or more output devices, such as a display screen, CRT monitor, LCD monitor, plasma display, printer, speaker devices, and the like, that enable data to be output or presented to a user. I/O device 725 may also include one or more digital and/or analog communication input/output devices that allow computing system 700 to communicate, for example, digitally, with other machines and devices. Other configurations and/or numbers of input and/or output devices may be incorporated in I/O device 725.

In the embodiment shown, system 700 is connected to a network 735 (such as the Internet, a private network, a virtual private network, or other network), which may in turn be connected to various systems and computing machines (not shown), such as personal computers, laptop computers, and/or smartphones of users 310 who wish to utilize optional coverages engine 210. In general, system 700 may input data from external machines and devices and output data to external machines and devices via network 735.

In the exemplary embodiment shown in FIG. 7, database 730 is a standalone database external to system 700. In other embodiments, database 730 may be hosted by system 700. In various embodiments, database 730 may manage and store data used to implement systems and methods consistent with the invention. For example, database 730 may manage and store data structures that contain selection rules 215, customer classification data 220, policy data 225, building data 230, account data 235, third party data 240, data describing base policy coverage 250 and location coverage 255, and data describing available optional coverages and computed optional coverages, such as optional coverages 260-275.

Database 730 may comprise one or more databases that store information and are accessed and/or managed through system 700. By way of example, database 730 may be an Oracle™ database, a Sybase™ database, or other relational database. Systems and methods consistent with the invention, however, are not limited to separate data structures or databases, or even to the use of a database or data structure.

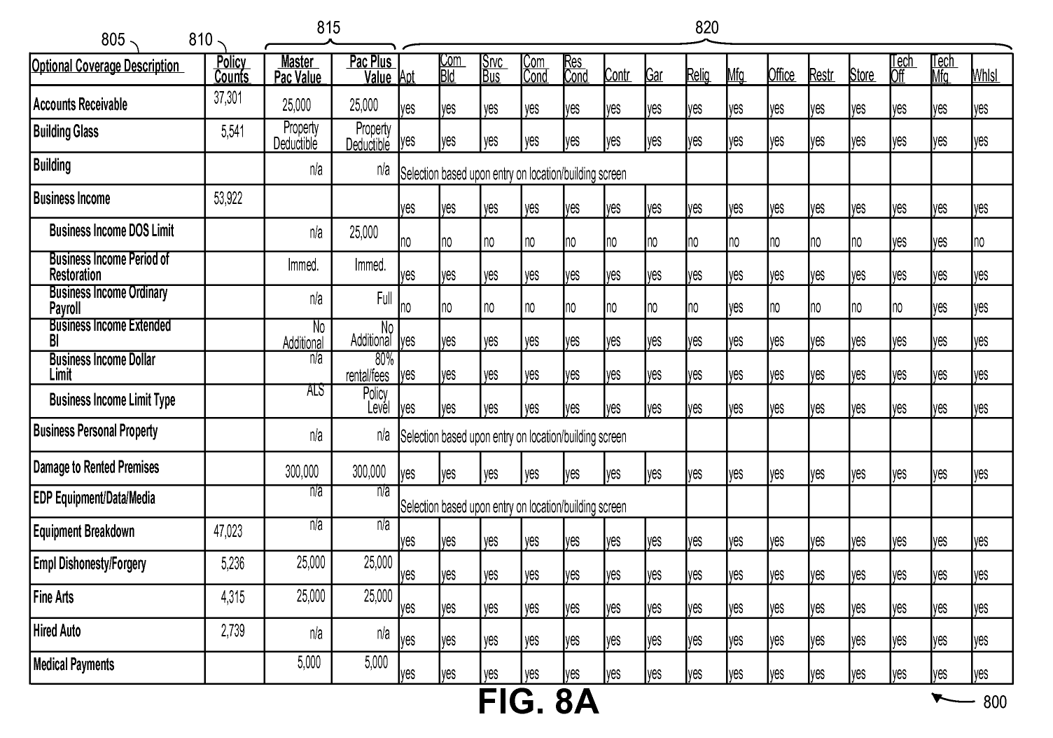

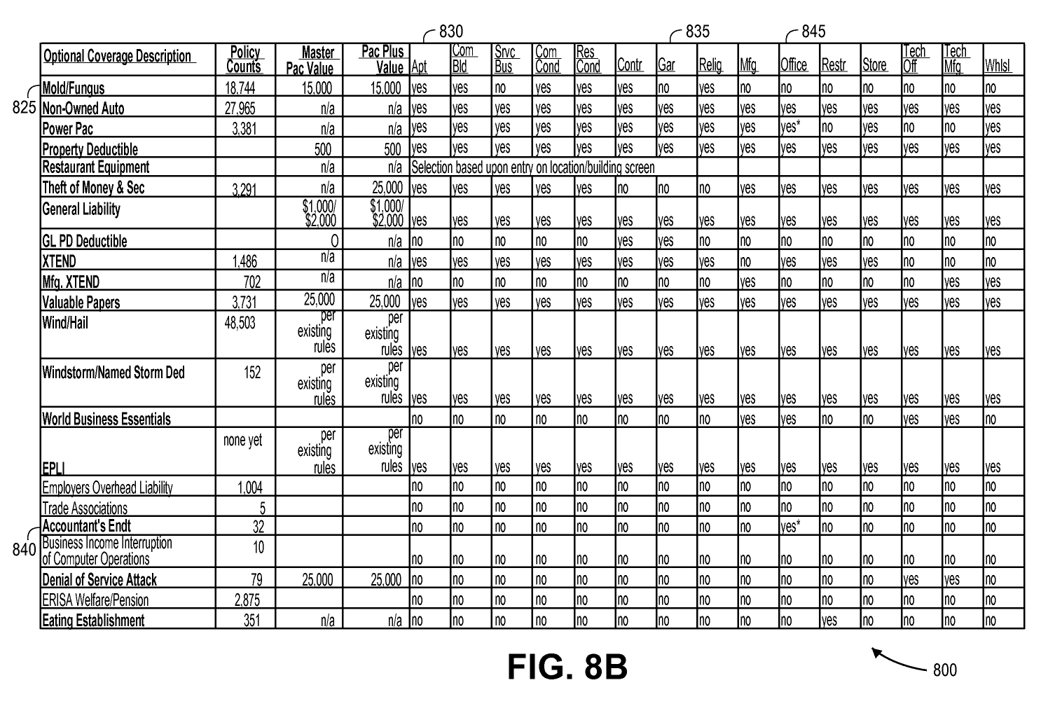

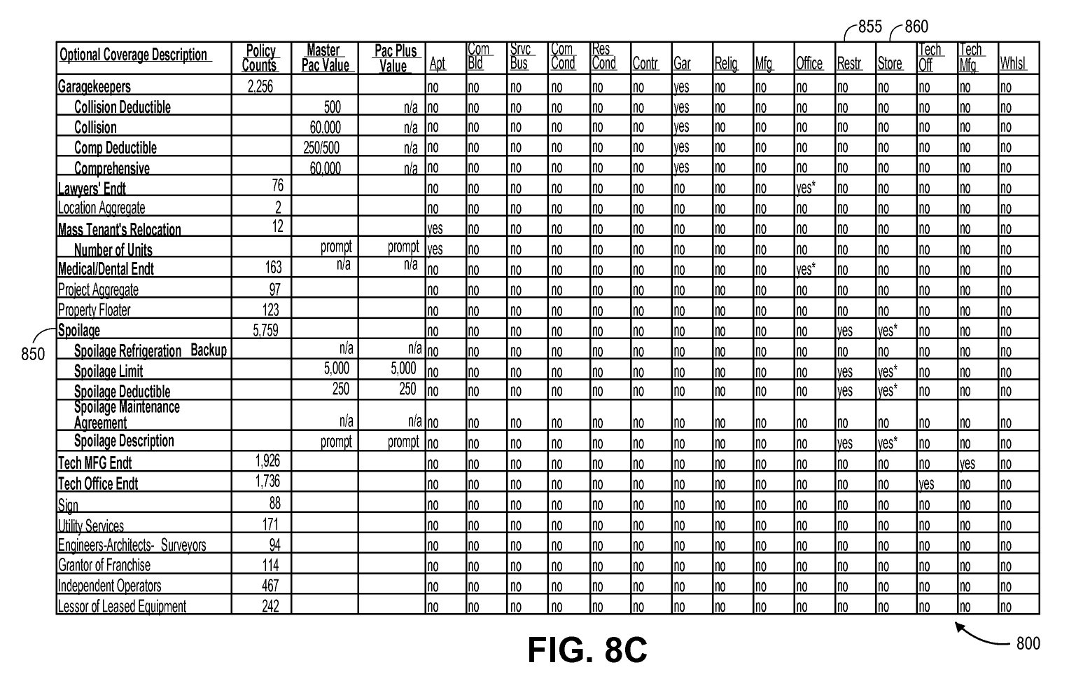

FIGS. 8A-8C depict an exemplary table 800 representing logic for determining optional coverages that are tailored for a specific customer. In various embodiments, the information in table 800 may be stored in a database, such as database 730 of FIG. 7, for use by CPU 705 in determining appropriate optional coverages for an insurance customer. In other embodiments, the information in table 800 may be stored in a data structure contained in storage 720 or memory 710, or it may be encoded in the logic of program 715 or otherwise used to direct the computations of CPU 705 that determine optional insurance coverages for a customer according to the characteristics of that customer. For example, table 800 may be used to define selection rules 215 used by optional coverages engine 210 to compute appropriate optional coverages for a customer.

Referring to the example shown in FIG. 8A, table 800 includes an “Optional Coverage Description” column 805, wherein each row lists an optional coverage that may be added to a base insurance policy, which in this example is a business owner's policy. Table 800 also includes a “Policy Counts” column 810, which tracks the number of issued policies that include the optional coverage listed in each row; “Master Pac Value” and “Pac Plus Value” columns 815, which indicate parameters, such as deductibles and coverage limits, associated with each row's optional coverage when that coverage is included in a “Master Pac” bundled product or a “Pac Plus” bundled product. Table 800 further includes business classification columns 820, which, in this example, list 15 business segments or categories into which a customer may be categorized.

The cells under each of the business classification columns 820 generally contain either a “yes” or a “no,” which represent whether or not the optional coverage listed in each row of Optional Coverage Description column 805 may be presented to a customer who falls into the business classification represented by each column. For example, referring to FIG. 8B, row 825 is the row for optional “Mold/Fungus” coverage. “Apt” column 830 is the column for customers that are categorized as apartment building businesses, “Gar” column 835 is the column for customers that are categorized as garage/auto service businesses, and “Office” column 845 is the column for customers that are categorized as office businesses providing professional services, such as medical, legal, or financial services. In the example shown, table 800 contains “yes” at the intersection of Mold/Fungus row 825 and Apartment business classification column 830, which indicates that optional Mold/Fungus coverage is appropriate to present to a customer falling into the Apartment building owner business classification. In contrast, table 800 contains “no” at the intersection of Mold/Fungus row 825 and Garage/auto service classification column 835, which indicates that optional Mold/fungus coverage should not be proposed to a customer whose characteristics place them into the garage/auto service business classification. Similarly, table 800 contains “no” at the intersection of Mold/Fungus row 825 and professional office business classification column 845, which again indicates that optional Mold/Fungus coverage should not be automatically presented to an insurance customer that operates a professional services office.

In various embodiments, a “yes” in table 800 may represent the first phase of a multiple-characteristic evaluation used to determine whether a particular optional coverage is suited for a particular customer. For example, in FIG. 8B at the intersection of “Accountant's End[orsemen]t” row 840 and professional Office classification column 845, table 800 contains “yes*,” where the asterisk indicates that other characteristics of the customer, in addition to the customer's business classification 820, should be evaluated to determine whether or not to propose Accountant's Endorsement optional coverage for the customer. For example, some embodiments may analyze characteristics regarding the type of profession that the customer is in, and if the customer's characteristics indicate that the customer's profession is “accountant,” such embodiments may choose the Accountant's Endorsement as an optional coverage to present to the customer. Expressed another way, such embodiments may implement a rule such as:
IF (classification=office business segment) AND (profession type=accountant) THEN
   optional coverage=accountant's endorsement.

A similar example may be seen with reference to FIG. 8C. In the example shown, the “yes” at the intersection of “Spoilage” optional coverage row 850 and “Restr” (restaurant) business classification column 855 indicates that optional Spoilage coverage should be presented to customers whose business operation characteristics place them into the Restaurant business classification. On the other hand, the “yes*” at the intersection of Spoilage optional coverage row 850 and “Store” (retail store) business classification column 860 indicates that optional Spoilage coverage may or may not be presented to customers whose business operation characteristics place them into the retail Store business classification, depending on other characteristics of each individual customer, such as characteristics indicating whether or not the customer sells perishable food items. While various multi-characteristic evaluation examples presented above assess just two customer characteristics to determine an optional coverage tailored to the customer, one of ordinary skill will recognize that three or more characteristics may also be used in other embodiments.

Further, one of ordinary skill will recognize that optional coverages may be added to, deleted from, or modified within, column 805, and that customer characteristics may be added to, deleted from, or modified within the business classification columns 820 without departing from the principles of the invention.

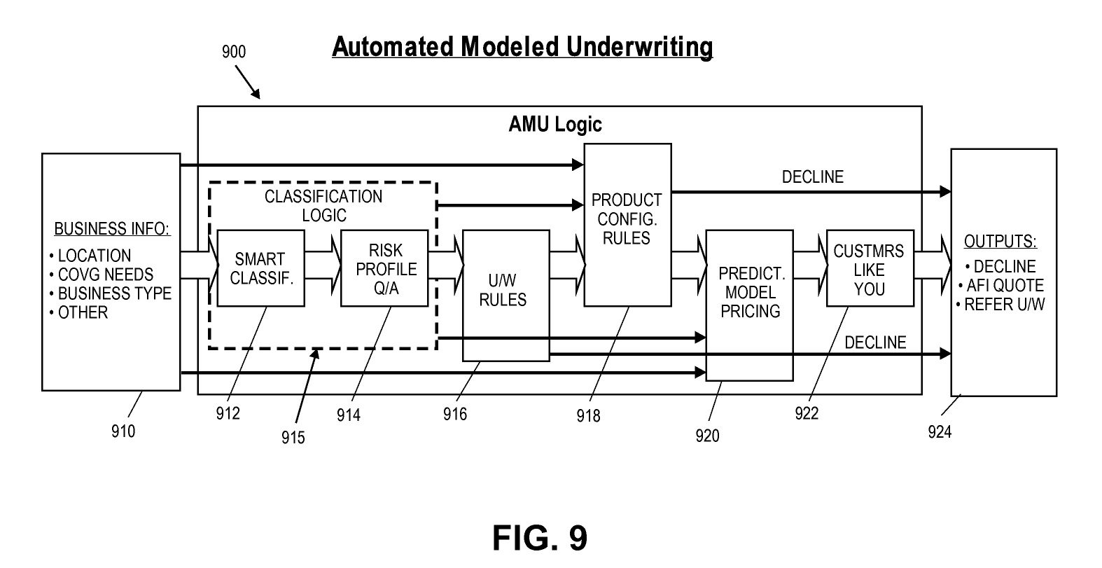

Referring to FIG. 9, in some embodiments, the present invention may be part of a larger system or logic, such as an Automated Modeled Underwriting (AMU) Logic 900. In that case, the AMU Logic 900 receives inputs 910 for optional Smart Classification logic 912 which may work with Risk Profile logic 914, shown collectively as Classification Logic dashed box 915, to identify the proper business classification for the business being priced, such as is described in U.S. patent application Ser. No. ______, (specified above). If the Classification Logics 912, 914, 915 are not used, the agent or user may select the classification and enter it into the AMU directly. The classification may be used by Underwriting Rules Logic 916 to validate quote eligibility based on risk characteristics and product selection. A result of the Underwriting Rules Logic 916 may be that the customer is declined a quote and the AMU 900 may cease further processing, or that the AMU 900 continues to Product Configuration Logic 918. The Product Configuration Logic 918, may use the Business Info. 910 and results from the Classification Logic 915 and the Underwriting Logic 916 to determine the appropriate product offering for the customer (e.g., available coverages, limits, and deductibles) based on risk characteristics (e.g., geographic location of the business, business classification, legal entity, and other relevant risk characteristics). A result of the Product Configuration Logic 918 may be that the customer is declined a quote and the AMU 900 may cease further processing, or that the AMU 900 continues to Predictive Model Pricing Logic 920. The Predictive Model Pricing Logic 920 may use the Business Info 910 and results from the Classification Logic 915, and determines the price (or rate or premium) for the desired coverage for the business by performing predictive model pricing with various risk characteristics (multivariable) to properly price each risk. Next, the AMU 900 may perform Customers Like You Logic 922, which determines one or more optional insurance coverages or features for the business policy, based a several factors, such as coverages/features that are used by other customers in the same or similar business area, or with the same or similar base insurance policy, or based on other factors, such as is described herein. A result of the Customers Like You Logic 922 may be that the customer is declined a quote, the customer is provided with a quote which is available for issue (or AFI), or the quote is referred to an underwriter for further consideration, as indicated by outputs box 924. The logics 912, 914, 916, 918, 920, 922 may be performed in any desired order, and certain logics may be performed concurrently and/or continuously, throughout the AMU 900 to provide the desired functions described herein. Also, the outputs 924 may come from the appropriate Logics 912-920 depending on the order performed.

The disclosed embodiments provide new, advantageous functionality for insurance management systems that: may allow optional coverages (and associated limits) to be added to a quote based upon, inter alia, a customer's operations and/or other characteristics, which may help avoid any coverage gaps; may highlight automatically added optional coverages for easy identification by agent/user; may automatically determine optional coverages based on an analysis of an existing book of business for similar operations and selected coverages; may enable the user/agent to customize or modify the presented automatic optional coverage(s); may enable the user/agent to delete the presented automatic optional coverage(s); and may eliminate the need for the user/agent to go through a multitude of screens/interfaces to select each optional coverage individually.

It will be apparent to those skilled in the art that various modifications and variations can be made to the structure and methodology described herein. Thus, it should be understood that the invention is not limited to the examples discussed in the specification. Rather, the present invention is intended to cover modifications and variations.

What is claimed is:

1. A method, implemented using a computing system, for determining optional insurance coverages for a customer, comprising:
receiving data representing characteristics of the customer;
determining a base insurance product for the customer, wherein a plurality of optional coverages is associated with the base insurance product;
determining, using the computing system, a set of optional coverages for the customer from among the plurality of optional coverages based on the data representing characteristics of the customer, and
presenting the set of optional coverages.

2. The method of claim 1, wherein determining the set of optional coverages for the customer comprises:
categorizing the customer into a business segment based on the data representing characteristics of the customer,
determining the set of optional coverages for the customer based on the business segment.

3. The method of claim 2, wherein determining the set of optional coverages for the customer based on the business segment comprises:
determining a set of purchased optional coverages purchased by at least one previous customer belonging to the business segment; and
designating the set of purchased optional coverages as the set of optional coverages for the customer.

4. The method of claim 3, wherein the at least one previous customer comprises a predetermined threshold of customers belonging to the business segment.

5. The method of claim 2, wherein categorizing the customer into a business segment based on the data representing characteristics of the customer comprises:
categorizing the customer into a business segment based on business operation characteristics of the customer.

6. The method of claim 1, further comprising:
analyzing issued insurance products of a group of insured customers having characteristics substantially the same as the characteristics of the customer to identify a threshold set of optional coverages utilized by a predetermined threshold of customers in the group; and
designating the threshold set of optional coverages as the set of optional coverages for the customer.

7. The method of claim 6, wherein the characteristics comprise at least one of a business segment and a risk profile.

8. The method of claim 1, wherein determining the set of optional coverages for the customer comprises:
determining the set of optional coverages for the customer based on a business objective of an organization that provides the base insurance product.

9. The method of claim 1, wherein determining the set of optional coverages for the customer comprises:
determining the set of optional coverages for the customer based on feedback from a previous customer of the base insurance product.

10. A system for computing optional insurance coverages comprising:
a memory containing instructions; and
a processor, operably connected to the memory, that executes the instructions to perform operations comprising:
receiving data representing characteristics of the customer;
determining a base insurance product for the customer, wherein a plurality of optional coverages is associated with the base insurance product;
determining, using the computing system, a set of optional coverages for the customer from among the plurality of optional coverages based on the data representing characteristics of the customer; and
presenting the set of optional coverages.

11. The system of claim 10, wherein determining the set of optional coverages for the customer comprises:
categorizing the customer into a business segment based on the data representing characteristics of the customer,
determining the set of optional coverages for the customer based on the business segment.

12. The system of claim 11, wherein determining the set of optional coverages for the customer based on the business segment comprises:
determining a set of purchased optional coverages purchased by a previous customer belonging to the business segment; and
designating the set of purchased optional coverages as the set of optional coverages for the customer.

13. The system of claim 11, wherein categorizing the customer into a business segment based on the data representing characteristics of the customer comprises:
categorizing the customer into a business segment based on business operation characteristics of the customer.

14. The system of claim 10, wherein the operations further comprise:
analyzing issued insurance products of a group of insured customers having characteristics similar to the characteristics of the customer to identify a threshold set of optional coverages utilized by a predetermined threshold of customers in the group; and
designating the threshold set of optional coverages as the set of optional coverages for the customer.

15. The system of claim 14, wherein the characteristics comprise at least one of a business segment and a risk profile.

16. The system of claim 10, wherein determining the set of optional coverages for the customer comprises:
determining the set of optional coverages for the customer based on a business objective of an organization that provides the base insurance product.

17. The method of claim 10, wherein determining the set of optional coverages for the customer comprises:
determining the set of optional coverages for the customer based on feedback from a previous customer of the base insurance product.

18. A method, implemented using a computing system, for determining optional insurance coverages for a customer, comprising:
receiving data representing characteristics of the customer;
categorizing the customer into a classification based on the data representing the characteristics of the customer;
determining, using the computing system, a set of optional insurance coverages for the customer based on at least the classification; and
presenting the set of optional insurance coverages.

19. The method of claim 18, wherein determining the set of optional insurance coverages comprises:
designating the set of optional insurance coverages to be equivalent to optional insurance coverages purchased by a predetermined percentage of previous customers belonging to the classification of the customer.

20. The method of claim 18, wherein categorizing the customer into a classification comprises:
determining a business segment classification for the customer from the data representing characteristics of the customer.

21. The method of claim 20, wherein determining the set of optional insurance coverages comprises:
determining the set of optional insurance coverages that corresponds to risks associated with the business segment classification.

22. The method of claim 18, wherein determining the set of optional insurance coverages comprises:
determining the set of optional insurance coverages based on a business objective of an organization that underwrites the optional insurance coverages.

23. The method of claim 18, wherein determining the set of optional insurance coverages comprises:
determining the set of optional insurance coverages for the customer based on feedback from a previous customer.

24. A method, implemented using a computing system, for determining optional insurance coverages for a customer, comprising:
receiving data representing characteristics of the customer;
determining, using the computing system, a set of optional insurance coverages for the customer based on optional coverages purchased previously by customers having characteristics substantially the same as the characteristics of the customer; and
presenting the set of optional insurance coverages.

25. The method of claim 24, wherein the customers comprise a predetermined threshold of customers having characteristics substantially the same as the customer.
